(19) United States
(12) Patent Application Publication
(10) Pub. No.: US 2016/0311632 A1
(43) Pub. Date: Oct. 27, 2016

(54) METHOD OF HANDLING AND/OR MANIPULATING ARTICLES LIKE PACKS OR PIECE GOODS

(71) Applicant: KRONES Aktiengesellschaft, Neutraubling (DE)

(72) Inventors: Christian WESTERMEIER, Oberaudorf (DE); Josef UNTERSEHER, Rohrdorf (DE); Manuel KOLLMUSS, Raubling (DE); Marco EHBERGER, Bad Aibling (DE); Michael HARTL, Raubling (DE); Peter ZEINER, Raubling (DE)

(21) Appl. No.: 14/941,979

(22) Filed: Nov. 16, 2015

(30) Foreign Application Priority Data
Nov. 17, 2014 (DE) 102014223393.3

(51) Int. Cl. B65G 47/90; B25J 17/02; B25J 15/00; B25J 9/00

(52) U.S. Cl. CPC B65G 47/90; B25J 9/0051; B25J 17/0266; B25J 15/0028

(57) ABSTRACT

The present invention includes a method for the handling of articles such as packs, piece goods or the like. The method is performed with a device comprising an upper suspension, to which at least three rotatable driven actuating arms are attached. The device comprises a manipulator with one or more sets of clamping jaws for gripping the articles and which is mechanically coupled to the at least three actuating arms. A position of the manipulator can be defined by a movement of one or more of the at least three actuating arms via a linear guide. The linear guide is formed as a rotatable first shaft and connected to the manipulator in a torque proof manner. The manipulator is rotated together with the first shaft by a rotational movement of the first shaft. At least one actuating device designed as a second shaft passes through the linear guide and controls the one or more sets of clamping jaws for temporarily gripping and releasing of articles. The actuating device designed as a second shaft is rotated relative to the linear guide in order to operate the one or more clamping jaws.

### CLAIM OF PRIORITY

The present application claims priority to German Application DE 10 2014 223 393.3, filed Nov. 17, 2014, which is incorporated by reference.

### FIELD OF THE INVENTION

The present invention relates to a method for handling and/or manipulating articles, grouped articles, packs or piece goods.

### BACKGROUND OF THE INVENTION

Known packaging or palletizing plants used for stacking and palletizing objects such as packages or packs made of several articles such as beverage containers usually comprise horizontal conveying devices with conveyor belts on which the piece goods or packs are conveyed in succession continuously or irregularly to a subsequently arranged handling device. The handling device shifts, orients and/or rotates the individual piece goods or packs in order to bring them into a suitable spatial arrangement. This spatial arrangement forms a base for pushing together the piece goods or packs into a stackable layer of piece goods or a stackable layer of packs by subsequently arranged grouping stations.

In currently used filling lines and packaging lines different methods for rotating packs are used. The methods, for example, comprise the use of suitable movable stops or the use of two conveyor belts running at different speeds. Known handling devices can also be provided with grippers, whereby the grippers are for example suspended from a gantry system and whereby the grippers can be moved within a defined range of motion, whereby the grippers can be rotated and whereby the grippers can also be moved in a vertical direction in order to raise the individual piece goods or packs for rotation and/or for shifting. The grippers can also be arranged, for example, on multi-axis robot arms, whereby the robot is placed alongside the horizontal conveying devices.

In order to offset and/or orient piece goods or packs according to such a handling the piece goods or packs are recognized, lifted and transferred or oriented to a desired position and orientation within a grouping. For this purpose numerous gripping devices are already known from the prior art, for example from EP 2 388 216 A1. This known gripping device comprises two horizontally spaced gripping arms, the gripping arms being arranged on an intermediate support via mechanical connections. The gripping arms can be moved towards each other in order to capture objects. Further, the gripping arms are releasable from the support by applying a defined force in the vertical direction and in opposition to the support. At the free end each of the two gripping arms comprises clamping jaws which are in surface contact with the respective objects when capturing, for example grabbing, the object.

Another gripping device is shown, for example in DE 102 04 513 A1. Several opposing gripping arms are guided in a centerpiece. One gripping arm is displaceable, especially shiftable, by means of an actuator with respect to a further gripping arm, so that both gripping arms can be closed. At the lower ends of the gripping arms and on the sides of the gripping arms facing each other gripping sections are provided for gripping building material packages.

In addition, there are other handling devices known and used for gripping, shifting, rotating and/or displacing articles or packs, which are based on so-called delta robots or parallel kinematics robots. Delta robots or parallel kinematics robots in a three-arm design are referred to as tripods. Each arm of such a tripod or delta robot consists of a upper arm and a lower arm. The upper arm is pivotably fixed to a base and can be driven around, especially swiveled around, a frame-fixed swiveling axis. Each arm furthermore comprises a lower arm that is hinged to the upper arm and a coupling element. The lower arm is passive, especially the upper arm has no own drive for performing the pivoting movement with respect to the upper arm or the coupling element. One or more of the lower arms can, for example, be connected to the respective associated upper arms and the coupling element via ball-and-socket joints. Such a lower arm swivels freely and has no inherent stability. All upper arms of a delta robot are preferentially mounted pivotally driven to respective swiveling axes, whereby all the swiveling axes are preferably located within a common plane. Three lower arms, each connected to the coupling element and to its associated upper arm, form a force triangle in any position of the arms. The force triangle can only be moved when the three upper arms synchronously execute a calculated pivoting movements about their frame-fixed swiveling axes. Two or more swiveling axes may run in parallel. Usually all swiveling axes have two intersections with other swiveling axes.

At least one of the lower arms may consist of two linkage elements in order to guide the coupling element in at least a predetermined orientation relative to the base.

The two linkage elements are also known as the radius and ulna and form a parallelogram linkage. The coupling element serves as a working platform, which is referred to in practice as a tool center point (TCP). A manipulator can be attached to this TCP, for example, in the form gripping arms or the like handling devices. The gripping arms are movable relative to one another, especially towards each other. The manipulator can grab and rotate, shift and lift articles, packs or the like piece goods from a support surface.

The manipulator arranged on the working platform or the TCP may optionally be mounted rotatable in order to align the manipulator or in order to perform a desired rotation of the articles or piece goods. Instead of a drivable rotatable mount of the manipulator on the coupling element it is also conceivable, in principle, that the manipulator is non rotatable mounted to the coupling element. Instead the entire coupling element can be twisted relative to the base with a corresponding compensation movement of the arms by means of a telescopic shaft. Associated therewith is the disadvantage of a limited angle of rotation of the coupling element. The limitation results from a reaching of end stops of the articulated joints of the upper arms and/or the coupling element with the lower arms and/or the mutual contact of adjacent lower arms.

Such handling device with tripods are known from DE 10 2010 006 155 A1, DE 10 2013 208 082 A1 and U.S. Pat. No. 8,210,068 B1.

The known parallel kinematic robots or so called tripods can cover a certain working space available for each robot. The working space results from the length of the upper arms, the distance between the fixing of the upper arms to the center of a frame-mounted base, the length of the lower arms, the distance between the fixing of the lower arms to the center of the so-called tool center points on the tool carrier and the maximum swiveling range of the upper arms. This working space covers a cylinder in the z-direction relative to the tool center point, with a spherical segment adjoined to the lower edge of the cylinder. Furthermore, the working space may be limited at the upper edge by a maximum swiveling angle of cardan telescopic drive shafts.

Known delta robots or tripods show a high precision and can be moved quickly in order to handle each article. Known tripods have movable manipulators in order to receive the respective articles and to release the respective articles after handling or positioning. The manipulators can be controlled, for example, pneumatically, hydraulically or electrically, therefore line connections are coupled to the corresponding manipulator. With regard to a freedom of movement of the tripod these line connections can be a hindrance. In addition, the line connections must be installed in such a secure manner that any risk of damage of the line connections during the operation of the tripod can be excluded. For this reason, especially due to the complicated coupling between the manipulator and an associated actuator, tripods of the prior art show a complex structure and a partially restricted freedom of movement.

### SUMMARY OF THE INVENTION

A primary objective of the present invention can be seen in providing an improved method for the handling of articles, packs, groups or piece goods which allows a handling of the articles, packs etc. with sufficient freedom of movement and high positioning accuracy. In addition, the method should be simple to implement.

This object of the invention is achieved with the subject matter of the independent method claim. Features of advantageous embodiments of the invention can be found in the dependent claims. To achieve said objective the present invention proposes a method for handling and/or manipulating articles, groupings, packs or piece goods, which is carried out with a device. The device comprises an upper suspension to which at least three rotatable driven actuating arms are attached. The at least three actuating arms each consist of at least two arm segments, whereby the two arm segments of each arm are pivotable relative to one another and whereby the at least three actuating arms can be operated independently of each other. The device furthermore comprises a manipulator comprising one or more sets of clamping jaws for gripping the articles. The manipulator is mechanically coupled to the at least three actuating arms. Therefore a movement of one or more of the at least three actuating arms can affect and define a position of the manipulator. In addition, the device comprises a linear guide that is connected to the manipulator and the suspension in each case via a cardan joint. The linear guide is formed as a rotatable first shaft that is connected to the manipulator via a torque proof connection. The manipulator is rotated together with this first shaft during a rotational movement of the first shaft. In addition, an actuating device designed as a second shaft is provided. The actuating device passes through the linear guide and drives and/or controls one or more sets of clamping jaws for temporarily gripping and releasing of articles. Thereby the actuating device designed as a second shaft is rotated relative to the linear guide in order to drive and/or control the one or more sets of clamping jaws for temporarily gripping and releasing of articles. When the first shaft which is in a torque proof connection with the manipulator is rotated, the second shaft performs a rotation in the same direction as the first shaft, optionally the second shaft performs a synchronous rotation with the first shaft or the second shaft performs a compensation movement or a counter-rotational movement to the first shaft depending on a status of the clamping jaws for temporarily gripping and releasing the articles

In this way it can be ensured that, if required, a rotation of the first shaft, through which the manipulator is rotated, leads to a compensation movement or a counter-rotational movement of the second shaft in order to maintain the operation or release of the clamping jaws for temporarily gripping and releasing the articles. It is also possible, that a rotation of the first shaft, through which the manipulator is rotated, leads to a rotation of the second shaft in the same direction or to a synchronous rotational movement of the second shaft, thereby amending an operation or release status of the clamping jaws for temporarily gripping and releasing the articles.

The manipulator can be preferably rotated by a rotational movement of the first shaft by up to 360° or more than 360°. The actuating device designed as a second shaft can show an orientation that is approximately concentric to the linear guide, whereby the orientation is being maintained continuously throughout a positioning of the manipulator via one or more of the at least three actuating arms.

Furthermore, a variation of the method according to the invention can provide that the actuating device designed as second shaft is connected to the one or more means via a gearing with at least one transmission ratio. The gearing transmits a torque of the actuating device designed as second shaft into an actuating movement of the one or more means. The said one or more means may, for example, comprise at least two clamping jaws arranged opposite each other, which are moved relative to one another upon a relative rotational movement between the actuating device designed as a second shaft and the linear guide. Thereby the articles, piece goods or packs can be grabbed and moved, rotated or lifted and displaced.

Optionally, the actuating device designed as second shaft can be controlled via a separate actuator, which is mounted rotatable and sitting on the upper suspension.

The invention provides a possibility to introduce additional drive possibilities in the so-called tool center point or in the tool carrier of tripods or similar robots, without this leading to disadvantages in the operating logic. According to one embodiment, where two interlocking shafts are mounted between the center of the suspension and the tool center point, two or more operating possibilities or actuation possibilities can be transmitted to the tool center point via, for example, rotational movements. For example, a rotational movement of one shaft can be used for closing the clamping jaws while an rotational movement of a coaxial shaft can be used for rotating a complete gripper, whereby the rotational movements of the two shafts are independent if each other. If only one rotational movement is to be performed, for example, the rotation of a gripper, the clamping jaws open or close because of a halt of the other shaft relative to the first mentioned shaft. The movement of the clamping jaws is a result of a relative movement between the two shafts.

According to the present method the second shaft which is used for closing and opening the gripper, has to perform a compensation movement when the gripper is rotated by an operation of the first shaft. This compensation movement takes place as a movement relative to the first shaft either in unison, in the opposite direction or synchronously. The direction of compensation movement depends on the desired function. If, for example, the grippers are closed by a rotational movement in the counter-clockwise direction and the gripper is rotated counter-clockwise, then the second shaft must also rotate in the counter-clockwise direction during rotation of the gripper in order to prevent an opening of the clamping jaws. A clockwise rotation is to be implemented similarly. The required direction of rotation of the shafts depends on the technical execution of the conversion of the rotary movement of the second shaft into a linear movement of the clamping jaws. Overall, by performing a compensation movement the desired function of the tool, for example, the gripper, can be achieved and ensured.

In preferred embodiments, the articles can be transported on a horizontal conveying device during their handling. The articles are hereby grabbed by the manipulator. After grabbing an article the manipulator can cause a rotation of the respective article and/or a lateral offset of the respective article at an angle to the transport direction of the horizontal conveying device and/or a delay of the respective article and/or an acceleration of each gripped article relative to a transport speed of the horizontal conveying device.

### BRIEF DESCRIPTION OF THE FIGURES

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows a schematic perspective view of an embodiment of a handling and/or manipulation device for performing the method according to the invention.

FIG. 2 shows a schematic detailed view of a lower part of the device shown in FIG. 1.

FIG. 3 shows a schematic cross-sectional view of the device according to the embodiment shown in FIG. 1 and FIG. 2.

### DETAILED DESCRIPTION OF THE INVENTION

The same or equivalent elements of the invention are designated by identical reference characters. Furthermore and for the sake of clarity, only the reference characters relevant for describing the respective figure are provided. It should be understood that the embodiments described are only examples of the method according to the invention and they are not intended to limit the scope of the disclosure.

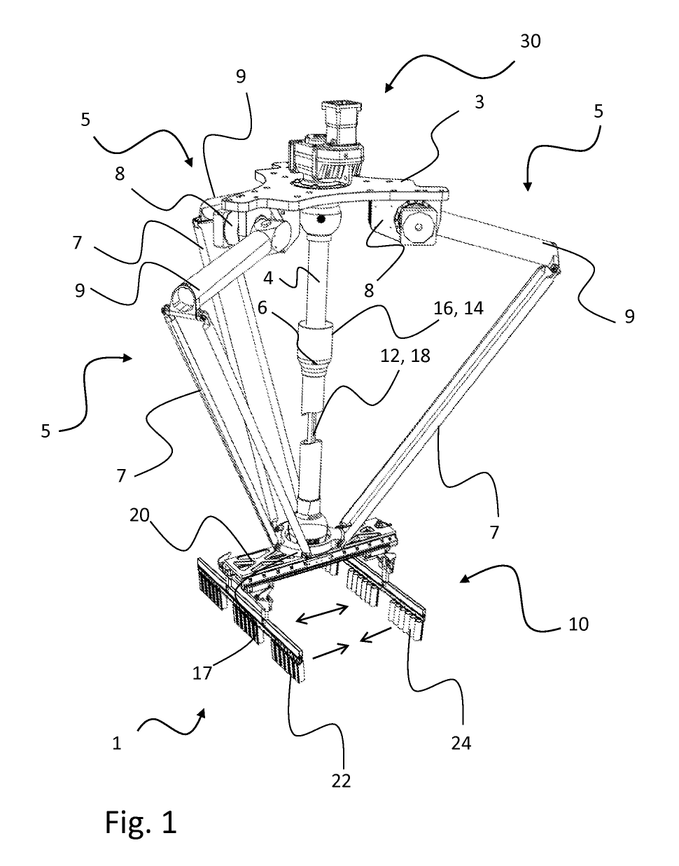

At this point it should be noted that the embodiments shown and described in FIGS. 1 to 3 of the device for performing the method according to the invention refer to a delta robot with three similar swiveling arms or a tripod. The delta robot or tripod is part of a handling device or a manipulator for handling, rotating, shifting or receiving articles, piece goods or packs. With regard to a possible embodiment of the delta robot or tripod, its structure, functioning and its movement space reference is made in particular to the disclosure of DE 10 2013 106 004 A1. Reference is hereby expressly made to the entire contents of this document. At this point a detailed description of the modes of movement, the drives for the three swiveling arms etc. should therefore be dispensed with. Basically, the device 1 according to FIG. 1 to FIG. 3 could also comprise four similar swiveling or actuating arms.

FIG. 1 shows a schematic perspective view of an embodiment of a device 1 for performing the method according to the invention. The device 1 is, for example, constructed for gripping, rotating and shifting of beverage containers grouped into packs; the packs are not shown in FIG. 1. However, the device 1 can likewise be used for gripping, rotating and shifting of any articles or piece goods.

As can be seen in FIG. 1, the device 1 comprises an upper suspension 3. On the upper suspension 3 three actuating arms 5 are each rotatable mounted on respective associated drives 8. The rotating movement of the actuating arms 5 takes place in such a way that their axes of rotation are parallel to one another. The three actuating arms 5 each consist of at least two arm segments 7 and 9, the arm segments 7 and 9 of each actuating arm 5 are pivotable relative to each other. The lower arm segments 7 or lower arms 7 are each made of two parallel-oriented linkages. The respective upper arm segment 9 or upper arm 9 is connected to the respective drive 8 or is flanged to its respective associated drive 8. In addition, the three actuating arms 5 can be moved independently of each other. For this purpose all drives 8 are connected to a control unit. The control unit affects and/or defines the movement of the actuating arms 5 and controls the drives 8.

At the lower end of the three actuating arms 5 a manipulator 10 is connected to the three actuating arms 5 in such a way that the manipulator 10 can be moved for the handling of the articles via a movement of the three actuating arms 5. Therefore, the control unit, not shown in FIG. 1, defines the movement of the actuating arms 5 as a function of an intended position of the manipulator 10 for gripping and handling the articles. All three actuating arms 5 are mechanically coupled to a base 20 of the manipulator 10 via a support ring 17. The mechanical connection or coupling between the support ring 17 and the base 20 of the manipulator 10 allows a rotation of the manipulator 10 relative to the support ring 17. The support ring 17 may be referred to as tool center point of the device 1.

Approximately centrally, the manipulator 10 is flanged rotatable to a linear guide 16. The linear guide 16 is designed as a first shaft 14. Thus, the manipulator 10 can be rotated by the first shaft 14.

Furthermore an actuating device 12 designed as a second shaft 18 is provided, by which the closing and opening of clamping jaws 22 and 24 can be controlled. The axes of rotation of the first shaft 14 and the actuating device 12 designed as a second shaft 18 are identical. The first shaft 14 and the second shaft 18 are coaxially oriented or arranged. As the manipulator 10 as well as the opposing clamping jaws 22 and 24 of the manipulator 10 can be controlled by the actuating device 12 designed as a second shaft 18, no pneumatic, hydraulic or electrical line connections connected to the manipulator 10 are necessary for controlling and/or driving the manipulator 10 or the clamping jaws 22 and 24.

Advantageously, it is possible to rotate the manipulator 10 together with its clamping jaws 22 and 24 via the first shaft 14 about an angle of more than 360°, since no line connections hinder a complete rotation. This can significantly improve the throughput during handling of articles in comparison to devices known from the prior art because there is no need to turn back the manipulator 10 in order to transfer it into an initial orientation.

As just mentioned, the two clamping jaws 22 and 24 of the embodiment shown in FIG. 1 can be adjusted relative to each other or moved towards one another and moved away from one another by a rotation of the actuating device 12 designed as a second shaft 18. The respective movement of the clamping jaws 22 and 24 controlled and driven by the actuating device 12 designed as a second shaft 18 is illustrated herein by arrows. Both clamping jaws 22 and 24 are connected to the base 20 of the manipulator 10, especially they are both suspended from and linearly movably to the base 20 of the manipulator 10. An activation and/or control of the clamping jaws 22 and 24 takes place via transmission ratios of a gearing which is connected to the second shaft 18. The gearing is not visible in FIG. 1. Thereby a torque of the second shaft 18 is translated into an actuating movement or operation movement of the clamping jaws 22 and 24.

The linear guide 16 or the first shaft 14 comprises two housing parts 4 and 6, which are telescopically connected with each other, each providing a cavity for receiving the actuating device 12 designed as a second shaft 18. The actuating device 12 designed as a second shaft 18 is coupled to the manipulator 10 and to an actuator 30 via a cardan joint.

The actuator 30 is connected to and sits on the upper suspension 3 in a torque proof manner. The actuating device 12 designed as a second shaft 18 may be rotationally moved via the actuator 30, whereby the clamping jaws 22 and 24 of the manipulator 10 are moved towards each other or away from each other in order to grip or release the articles.

According to the inventive method the second shaft 18, which serves for closing and opening the clamping jaws 22 and 24 of the manipulator 10, has to perform a compensation movement when the manipulator 10 is rotated by the actuation of the first shaft 14. This compensation movement takes place as a movement relative to the first shaft 14 in synchronism, in the opposite direction or synchronously. The direction of compensating movement depends on the desired function. If, for example, the clamping jaws 22 and 24 are closed by a counter-clockwise rotary movement of the second shaft 18 and if, simultaneously, the manipulator 10 is rotated by a counter-clockwise rotation of the first shaft 14, than the second shaft 18 must also perform a counter-clockwise rotation during the rotation of the manipulator 10 to prevent an opening of the clamping jaws 22 and 24. Similarly, a clockwise rotation is to be implemented. The required directions of rotation of the shafts 14 and 18 are dependent on the technical execution of the conversion of the rotary movement of the second shaft 18 into a linear movement of the clamping jaws 22 and 24.

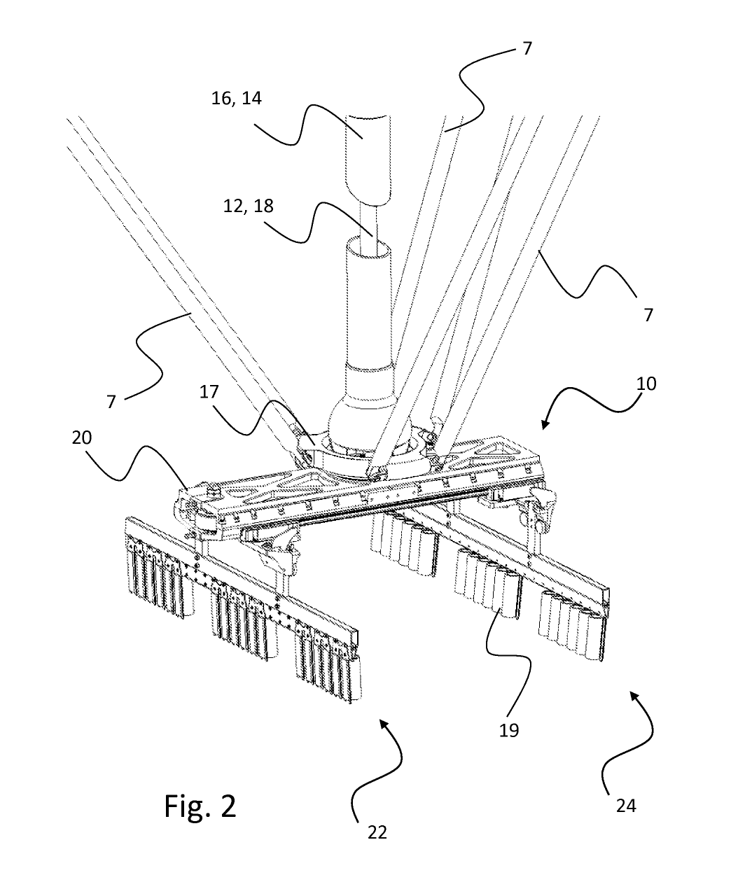

The schematic detailed view according to FIG. 2 shows a lower part of the device 1 according to FIG. 1. Especially it shows an embodiment of the manipulator 10 in detail, as may be provided and can be used for the method according to the invention.

For the gripping of articles the clamping jaws 22 and 24 each have multiple flexible contact elements 19 on their respective side facing the opposite clamping jaw 22 or 24. When the clamping jaws 22 or 24 are moved towards each other, the flexible contact elements 19 are forced against the articles and brought into abutment with the articles, thereby immobilizing the respective articles at the manipulator 10.

FIG. 2 also shows in detail the lower arm segments 7 of the actuating arms 5 (see FIG. 1), each of which is designed as a linkage construction and each of which is connected in an articulated manner at its lower end to the support ring 17 (or the so-called tool center point). As already mentioned previously, the manipulator 10 can be rotated relative to the support ring 17 via the first or outer shaft 14.

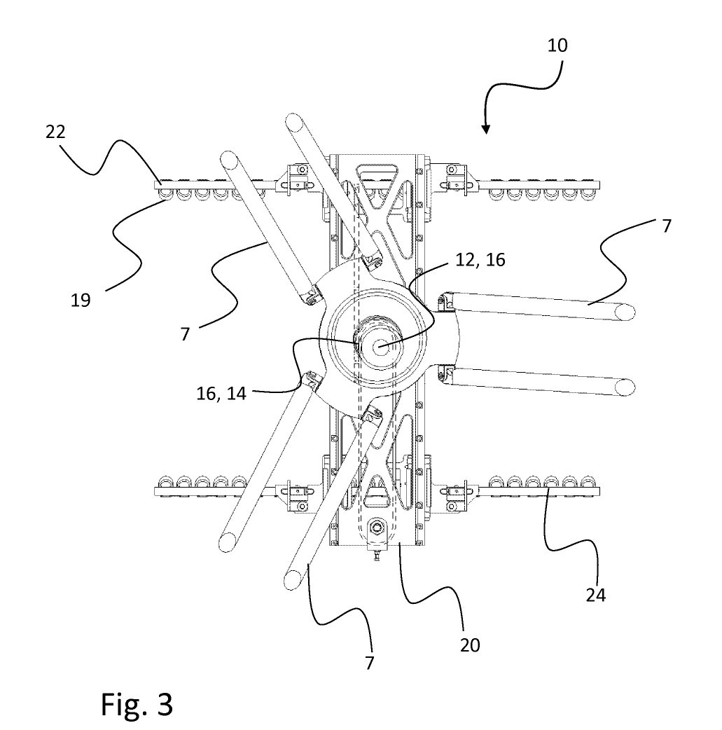

The schematic cross-sectional view of FIG. 3 shows further details of the device 1 according to the embodiment shown in FIG. 1 and FIG. 2. Especially the actuating device 12 designed as a second shaft 18 and the linear guide 16 designed as the first shaft 14 can be seen again in FIG. 3. The second shaft 18 and the first shaft 14 each have a concentric orientation and an identical axis of rotation; this means that they are arranged coaxially to one another. A rotation of the manipulator 10 can be effected by linear guide 16 designed as the first shaft 14, wherein the rotation axis in FIG. 3 is oriented vertically or in the direction of the image plane.

As already mentioned previously a compensating movement of the inner second shaft 18 either in the same direction or in the opposite direction is required during rotation of the manipulator 10 which is induced by a rotation of the outer first shaft 14. The compensating movement of the inner second shaft 18 prevents an unwanted operation of the clamping jaws 22 and 24, especially this compensating movement prevents an opening or further closing of the clamping jaws 22 and 24. The extent of this compensating movement depends on the one hand on the kinematic linkage of the actuators, which are operated by the second shaft 18. For example, the extent of this compensating movement depends on the translation of these actuators. Thus, depending on the translation different rotation angles of the compensating movement may be required. In addition, the compensation movement depends on the direction of rotation of the first shaft 14, which requires a compensating movement of the second shaft 18 in the opposite direction or in the same direction in order for the clamping jaws 22 and 24 to remain unchanged in their either closed or opened setting during the rotation of the manipulator 10.

The invention has been described with reference to preferred embodiments. To the expert it is also conceivable, however, to make changes and modifications without leaving the scope of protection of the appended claims.

### LIST OF REFERENCE NUMERALS

1 device
3 suspension, upper suspension
4 first housing part
5 actuating arm
6 second housing part
7 lower arm segment, lower arm
8 drive
9 upper arm segment, upper arm
10 manipulator
12 actuating device
14 first shaft
16 linear guide
17 support ring
18 further shaft, second shaft
19 contact element
20 base
22 clamping jaw
24 clamping jaw
30 actuator

1. A method of handling articles such as packs, piece goods or the like with a device comprising:
an upper suspension (3), to which at least three rotatable driven actuating arms (5) are attached, wherein the at least three actuating arms (5) each consist of at least two arm segments (7, 9), whereby the two arm segments (7, 9) of each actuating arm (5) are pivotable relatively to one another and can be operated independent of each other;
a manipulator (10), which comprises one or more sets of clamping jaws for gripping articles and which is mechanically coupled to the at least three actuating arms (5), so that a position of the manipulator (10) can be defined by a movement of one or more of the at least three actuating arms (5);
a linear guide (16) which is connected to the manipulator (10) and to the suspension (3) in each case via a cardan joint, wherein the linear guide (16) is designed as a rotatable first shaft (14), the first shaft (14) being in rotatable connection with the manipulator (10) and wherein the manipulator (10) is rotated together with the shaft (14) by a rotational movement of the first shaft (14); and
a second shaft (18) that passes through the linear guide (16) and which controls the one or more sets of clamping jaws for temporarily gripping and releasing of articles,
wherein the second shaft (18) is rotatable relative to the linear guide (16) in order to control the one or more sets of clamping jaws;
wherein the first shaft (14) is connected to the manipulator (10) in a torque proof manner,
wherein, upon rotation of the first shaft (14) and depending on a status of the one or more sets of clamping jaws, the second shaft (18) stays stationary, rotates in the same direction with the first shaft (14) or rotates in the opposite direction as the first shaft (14).

2. The method of claim 1, wherein a rotation of the first shaft (14) rotates the manipulator (10) and wherein the rotation of the first shaft (14) causes a counter-rotational movement of the second shaft (18) in order to maintain or amend the operation or release of the sets of clamping jaws for temporarily gripping and releasing the articles.

3. The method of claim 1, wherein a rotation of the first shaft (14) rotates the manipulator (10) and wherein the rotation of the first shaft (14) causes a rotation of the second shaft (18) in the same direction as the first shaft (14), in order to maintain or amend the operation or release status of the sets of clamping jaws for temporarily gripping and releasing the articles.

4. The method according of claim 1, wherein the manipulator (10) is rotated at least 360° by a rotary movement of the first shaft (14).

5. The method of claim 4, wherein the second shaft (18) shows a concentric orientation towards the linear guide (16) and wherein the second shaft (18) maintains this orientation continuously during positioning of the manipulator (10) via one or more of the at least three actuating arms (5)

6. The method of claim 5, wherein the second shaft (18) is connected to the one or more sets of clamping jaws via a gearing with at least one transmission ratio, wherein the gearing transmits a torque of the second shaft (18) into an actuating movement or operation movement of one or more sets of clamping jaws.

7. The method of claim 6, wherein the one or more sets of clamping jaws comprise at least two opposing clamping jaws (22, 24), which are moved relative to each other during a rotation between the second shaft (18) and the linear guide (16).

8. The method of claim 7, wherein the second shaft (18) is controlled by an actuator (30) that is mounted onto the upper suspension (3) in a torque proof manner.
